(19) United States
(12) Patent Application Publication
(10) Pub. No.: US 2014/0081739 A1
(43) Pub. Date: Mar. 20, 2014

(54) SYSTEM AND METHOD FOR ADVERTISING ANALYTICS

(71) Applicants: Kenneth J. KALB, Solana Beach, CA (US); Mark H. SCHWARTZ, Livonia, MI (US); Thomas H. BUSCHER, Los Angeles, CA (US)

(72) Inventors: Kenneth J. KALB, Solana Beach, CA (US); Mark H. SCHWARTZ, Livonia, MI (US); Thomas H. BUSCHER, Los Angeles, CA (US)

(21) Appl. No.: 14/086,797

(22) Filed: Nov. 21, 2013

Related U.S. Application Data
(63) Continuation-in-part of application No. 13/231,914, filed on Sep. 13, 2011.
Application No. 13/231,914 is a continuation-in-part of application No. 12/009,280, filed on Jan. 17, 2008, now Pat. No. 8,090,613.

(51) Int. Cl. G06Q 30/02

(52) U.S. Cl. CPC G06Q 30/0242
USPC 705/14.41

(57) ABSTRACT

The system provides a method and apparatus for providing analytics to determine accountability of offers and ads. The system provides real time analysis of advertising effectiveness and permits modification of ad campaigns during the life of the campaign. The system also determines success and performance of an ad campaign on a per platform basis. The system includes an analystics engine that receives response data to an offer, along with metadata and metrics associated with the offer. The analytics engine utilizes historical data associated with a specific product, category of product, geographical area, temporal data, demographic data, platform of publishing, platform of response, and the like, along with response data from consumers during a campaign to determine the effectiveness of both online and offline advertising. The system allows the pricing of ads to be determined and to determine the value on a response platform basis.

This patent application is a continuation-in-part of U.S. patent application Ser. No. 13/231,914 filed Sep. 13, 2011 which is a continuation-in-part of U.S. patent application Ser. No. 12/009,280 filed on Jan. 17, 2008 (now U.S. Pat. No. 8,090,613), all of which are incorporated by reference herein in their entirety.

### BACKGROUND OF THE SYSTEM

The advent of the Internet and other digital platforms has had a significant impact on the economic model of so called “legacy” media, which includes most off-line media such as newspapers, radio, television, magazines, direct mail, and the like. Legacy media has traditioanally been an advertising driven model, with income generated through the sale of ads in publications. As the Internet has prospered, advertising has shifted to the digital world at the expense of off-line publications. The growth in internet advertising has had a negative effect on legacy media. Many newspapers, magazines, and radio stations are facing a budgetary crisis due to a loss of advertising revenues. One reason that legacy media has lost market share i advertising is the fact that these off-line media does not provide real accountability for advertising campaign performance. Because of this deficiency, advertisers are spending their marketing dollars in channels with knowable performance.

Publishers of legacy media have adapted to the new paradigm in some cases by adding digital online versions of their publications. However, not all of the users of off-line media will take advantage of the on-line content of a legacy publisher. In addition, there is a difficulty in acquiring known and exploitable customers to the on-line and off-line publications of legacy publishers. In addition, publishers have failed to become participatory in the revenue from advertising placed in their publications.

Even for on-line participants, there has been a reliance on outdated models of measuring effectiveness of advertising and other customer acquisition approaches. Further, there has been little to no incentive to cooperate with other publishers, whether on-line or off-line, to maximize customer acquisition opportunities and revenue generation.

### SUMMARY OF THE SYSTEM

The system provides a method and apparatus for providing analytics to determine accountability of offers and ads. The system provides real time analysis of advertising effectiveness and permits modification of ad campaigns during the life of the campaign. The system also determines success and performance of an ad campaign on a per platform basis. The system includes an analystics engine that receives response data to an offer, along with metadata and metrics associated with the offer. The analytics engine utilizes historical data associated with a specific product, category of product, geographical area, temporal data, demographic data, platform of publishing, platform of response, and the like, along with response data from consumers during a campaign to determine the effectiveness of both online and offline advertising. The system allows the pricing of ads to be determined and to determine the value on a response platform basis.

In one embodiment, the system may be part of a system and method for dynamic off-line ad campaign management and optimization and makes it possible to analyze the history of responses to a multitude of off-line advertisements and/or offers, and based on the garnered customer habits, an individual customer's preferences for various activities and products is analyzed and then compared jointly with that of other customers. This process allows accurate classification of each customer. The system then provides ever improving statistical analysis of the likes and dislikes of customers as their history of participation with the system increases. In other embodiments, the syndication network may be part of a more traditional advertising environment.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 illustrates an embodiment of the syndication network.

FIG. 2 illustrates an embodiment of an accountable campaign system.

FIG. 3 is a flow diagram illustrating an offer made to the syndication network in an embodiment of the system.

FIG. 4 is a flow diagram illustrating the selection of an offer from the syndication network in an embodiment of the system.

FIG. 5 illustrates the flow of an offer in an embodiment of the system.

FIG. 6 is a flow diagram illustrating the operation of the campaign management when a consumer responds to an offer.

FIG. 7 is a flow diagram illustrating one embodiment of defining offer metrics in the system.

FIG. 8 is an example computer environment for implementing the system.

FIG. 9 is a flow diagram illustrating an embodiment of campaign analysis and management at the publication instance level.

FIG. 10 is a flow diagram illustrating an embodiment of campaign analysis at the platform level.

FIG. 11 is a flow diagram illustrating an embodiment of the campaign analysis at the template level.

FIG. 12 is a flow diagram illustrating ad modification in one embodiment of the system.

FIG. 13 is a flow diagram illustrating a process for changing publishing frequency of variants in an embodiment of the system.

### DETAILED DESCRIPTION OF THE SYSTEM

The following description is merely exemplary in nature and is not intended to limit the present disclosure, application, or uses. It should be understood that throughout the drawings, corresponding reference numerals indicate like or corresponding parts and features.

The system can be advantageous to publishers, to financial institutions, to credit card companies, to manufacturers who are making products which they need to promote, vendors who need to advertise their products or services, and any advertising body, either for a department within a large corporation, or a standalone advertising agency creating campaigns for a multitude of disparate clients companies. These organizations are highly motivated to achieve return on their financial investment in marketing and advertising. Their advertising spending therefore needs to be evaluated in terms of its impact on customer acquisition. The impact thus measured will then allow quantitative measurement of the performance of each advertisement and make it possible based on this information to maximize logistical and economic efficiencies of the overall campaign. These organizations also have a strong desire to acquire customers.

The system provides a customer acquisition, revenue generating, and advertising accountability platform. The system contemplates a plurality of publishers, vendors, advertisers, and distributors in a synciation network. At any given moment, there are a plurality of offers available to members of the network. These offers can be from one or more members of the syncidation network itself, or from third parties.

In the example herein, an “offering publisher” introduces an offer to the sysndicate. One or more “receiving publishers” accept the offer and publish it on one or more of their publishing platforms. The offer contemplates a consumer or customer response.

The response may be a purchase, a request for information, a website visit, or some other response. The consumer can respond using smartphones, PDA's tablet and pad based computing devices, Google Glass, telephones, browser enabled devices, and the like. When a consumer responds, the system tallies that response and uses it to analyze the effectiveness of the offer. The system collects all the information that is available in the response from the consumer, including the timing of the response, the avenue of the response, the on-line or off-line format from which the response was generated, and, where available, registered user information. As noted above, the system may be implemented in a system where responders are (or become upon responding) registered users, or it can be implemented where none of the responders are registered users, or it can be a hybrid of registered and unregistered users.

In one embodiment, the system is implemented for both on-line and off-line environments. Any syndicate member may have off-line and/or on-line capabilities in a combined system. In other embodiments, the system may be implemented exclusively on-line or exclusively off-line.

One of the advantages of the system is the use of analytics to provide accountability for each ad or deal or offer implemented using the system. This provides the data to drive metrics associated with the offers and even the publishers so that intelligent and automated decisions may be made regarding syncidation of offers and sharing of revenue.

Network Syndicate Structure

In one embodiment, the system contemplates a network of publishers in a network syndicate, where the publishers participate in a shared campaign management system. The following is an example of such a network syndicate.

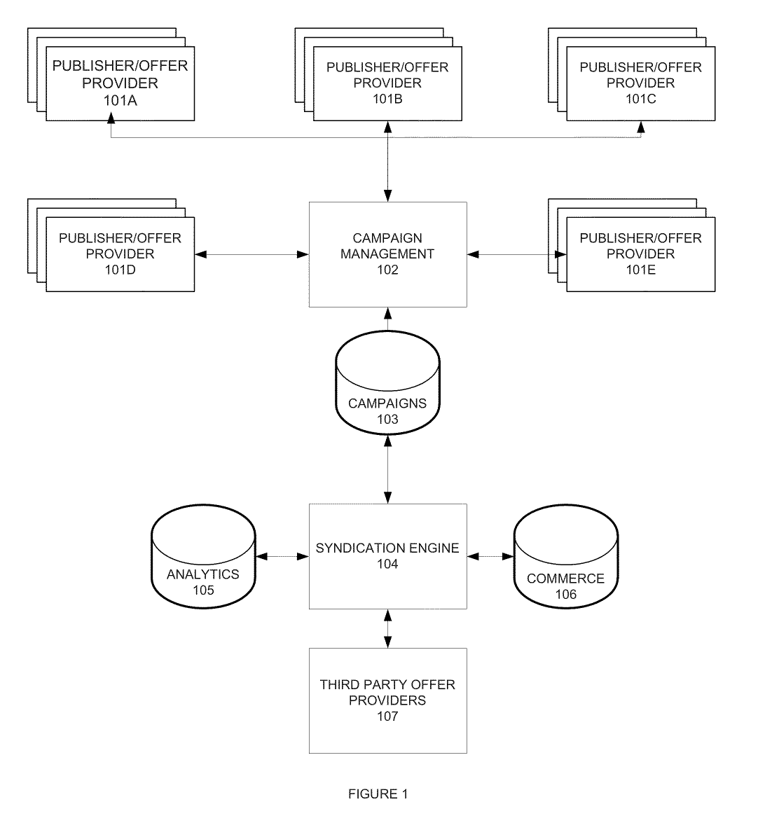

FIG. 1 illustrates a network syndicate structure in an embodiment of the system. The syndication network in one embodiment comprises a plurality of syndicate members 101A-101E of FIG. 1. In the example of FIG. 1, each syndicate member 101A-101E is shown as both a publisher and offer provider. However, the syndicate members may be one or the other. For example, a syndicate member may be solely a publisher and rely on others to generate offers that may be published by the publisher.

In other instances, the syndicate member may be solely an offer provider who relies on publishers to disseminate its offers. In addition, there may be third party offer providers 107 that are not necessarily part of the syndicate, but whose offers may be used by the syndicate and introduced by the syndicate management. Further, any syndicate member may introduce an offer from a third party source to the network.

The syndicate members are in communication with campaign management 102. Campaign management 102 is used to maximize campaign effectiveness through monitoring of a campaign to evaluate effectiveness of offers. This monitoring can take place in near real-time or on any desired schedule, so that the system becomes a close looped system that provides accountability to the offer campaign.

As can be appreciated, campaign management is applicable to various advertising campaign managers, including, but not limited to, manufacturers, goods and service providers, advertising departments, and advertising agencies. Essentially all kinds of merchants can make use of the invention to promote their particular business.

A syndication engine 104 is coupled to the campaign manager and to the analytics engine 105, commerce module 106, and third party offer providers 107. The syndication engine is used to manage the sharing and distribution of offers in the syndication network and to manage accounting and other relevant data associated with shared offers. The analytics engine 105 is used to analyze the performance of each offer in all media channels in which it may be published, and to provide metrics that can guide future offer selection by the syndicate members. The commerce module 106 is used to handle fulfilment and other transactional requirements associated with the offers in the syndication network.

Analytics System

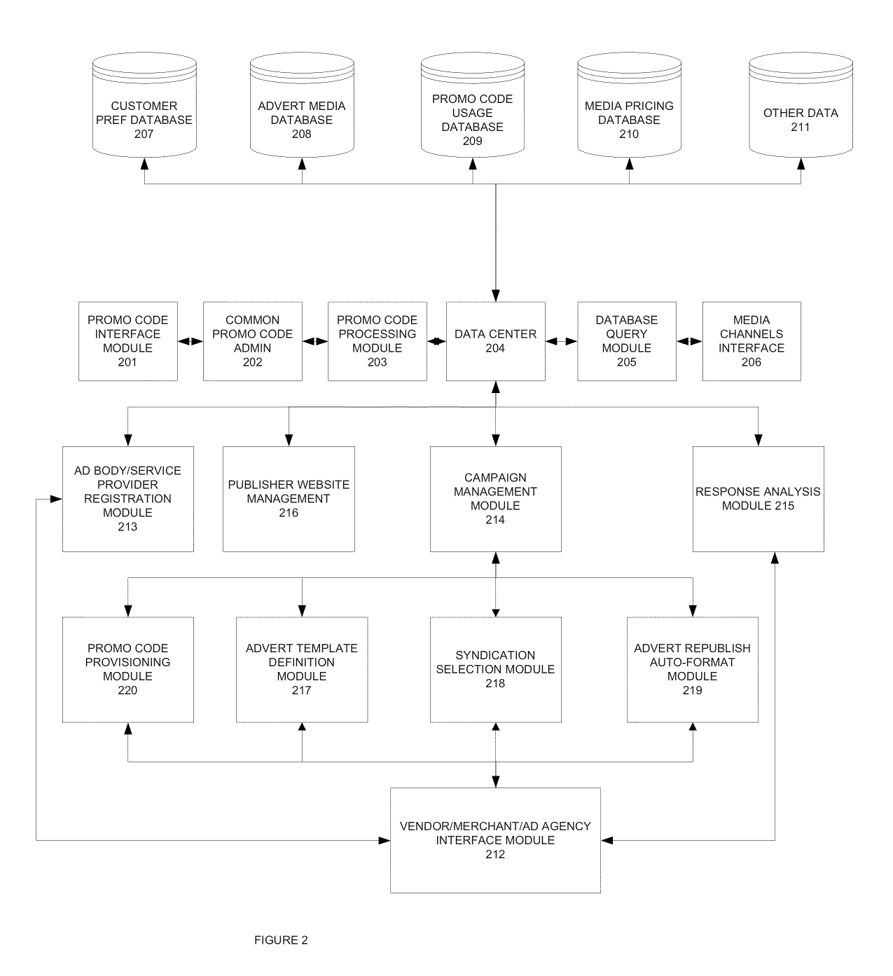

In one embodiment, the system is used as part of an analytics system such as is described in U.S. Pat. No. 8,090,613 which is incorporated by reference herein in its entirety. Such a system allows the modification of campaigns during the life of the campaing to optimize the effectiveness of the campaign. An example of such a dynamic analytics system is illustrated in FIG. 2. FIG. 2 is a block diagram illustrating the promo code embodiment of the system. The embodiment of the system includes a promo code interface module 201, a media channels interface module 202, a vendor/merchant or advertising body user interface module 203, a common promo code administrations interface module 204, a promo code processing module 205, a database query processing module 206, a good or service provider or advertising body registration module 207, an advertising campaign management module 208, a response analysis module 209, a data center 210 including a customer preference database 211, an advert media database 212, a media pricing database 213, and a promo codes usage database 214 among others, a promo code provisioning module 215, and a publisher website 216.

The system may also includes several additional modules, which make new functions possible for the cooperative publishing or syndication of advertisements. These include advert template definition capture module 217, which assists the overall system operator to collect essential information from merchants to be contained in their advertisement and associated special offer, syndication selection interface 218, which allows a source publisher to set parameters for other publishers that intend to syndicate the advertisement, and advert republish auto-format module 219, which allows any member publisher in the network to selected offers to republish the on their website and promote using their own traditional media channels.

The present disclosure describes various embodiments of a system and method for improved advertising using embedded surveys and ad monitoring, analytical analysis of ad effectiveness, all followed by improved performance feedback and especially centralized means to manage and control and to optimize the advertising campaign. In all its various embodiments the system can perform control of advertisement placement and scheduling for maximum efficiency of an off-line and/or on-line campaign while minimizing required efforts from a campaign manager. The system can be implemented within a single computer or be distributed over a number of devices.

It is appreciated that the modules and data structures shown may be combined and/or further partitioned to similarly perform campaign management. Various embodiments of campaign management and optimization methods and systems include alternative implementations and combinations of the above described elements as will be described in more detail below.

The vendor/merchant or advertising body user interface module 213 serves for configuration, and control of operation and display of the system. The advertising body user interface module 213 is used to provide input to a good or service provider or an advertising body registration module 213, an advertising campaign management module 214, and a response analysis module 214 (it should be noted that the response analysis module may also perform in real-time, near-real time, or in some other asynchronous manner where responses are received after offers are run and the system is able to associate responses to particular off-line channels as well as to particular time periods of ad presentation) These modules operate and interact with the central registry of information contained within data center 204. The data center 204 comprises a customer preference database 207, an advert media database 208, a media pricing database 210, a promo code usage database 209, and other database 211, among other databases.

The data in the customer preference database 207 is created in part by interactive collection from a customer that responds to offers and/or registers with one or more of the syndicate members. Additional information in the customer preference database 207 is accumulated over time using the system and tracking usage and response patterns of customers. This data is formed by the cumulative history of responses to offers.

The system of the present disclosure makes it convenient for the advertiser and/or publisher to provide offers to customers in order to increase the likelihood of their conversion. Conversion is the process by which a viewer purchases or subscribes to an advertiser's product or service. The word conversion describes how an advertiser might first encounter a viewer as a sales lead and then the lead would “convert” to becoming a customer by buying a product.

Creative advertisement or creative is a term used to describe the advertisement being used to promote or sell a product or service. The creative or advert media database 208 contains actual viewable or listenable content. The media database 208 content includes digital copies of the offers which will be published in a magazine, newspaper, or even roadside billboard displays. It also includes sound files in a digital format such as way, or mp3 files for play on radio commercials. Multi-media ads created for example for broadcast television, cable TV, and viewing in theaters before movies, can be stored in a number of formats in the digital database including among others, divx, avi, mpeg4, mpg, and wmv type files. The system uses the files stored in the media database to allow quick creative review by decision makers while using the analytical information to adjust the scheduling and geographical distribution of ads. The easy and organized access to review capability while simultaneously reviewing the performance data will allow creative design and also management teams, when collaborating on overall advertising strategies or adjusting demographic targets, to better predict the way to design an ad or position it in the marketplace to get the highest performance.

Media buy refers to the buying of advertising space from a company operating media properties such as TV, radio, newspapers, magazines and billboards or outdoor kiosks. The cost of a media buy varies depending on (1) the specific media property on which the buyer wants to advertise, (2) the size of the advertising campaign, (3) the specific times at which the advertisements are to be displayed, and (4) other specific features of the advertising campaign. The media pricing database 210 is built by entering pricing information either manually or automatically collected from the various media channels. Each media channel can have different means for calculating their pricing of an advertisement. Magazines for example run on a monthly basis and charge prices depending on ad size and position. Television commercial prices depend on length, time of day, and are related to the popularity of the show or program during which the spot is aired. The pricing database 210 contains all rules and formulas necessary to make complete price calculations for each media channel, and upon campaign configuration by the operator or user, is used to calculate the total cost for each particular ad included in the campaign along with overall campaign cost.

In one embodiment, the customer will be provided with what is termed here a “promo code”. In one embodiment, promo codes are to be used by the customer at web sites, such as advertiser or publisher web sites. The web site can be accessed by any web enabled device, including computers, PDA's, web enabled cell phones, Smart-Phones, and the like. In implementing a promo code, the publisher of the advert provides a website to which the viewer is invited to navigate. This web site may be a web site of the publisher, of the provider of the goods or services being advertised, or by a third party that implements the system on behalf of participating parties. Once at the web site, the customers will be directed or linked to a promotions web page which solicits the login of the user. Then, upon entry of the promo code the customer has full access to the offered special promotions. Examples of CTAs that can be used by the system include, but are not limited to, short codes, email, SEM, SEO, a web site (publisher, merchant, third party, etc), social media site (Facebook, Twitter, and the like), telephone number, RFID chip, bar code, QR (Quick Response) codes and the like, wireless mechanisms such as RFID codes and the like, and/or sound based response mechanisms such as audio response and the like, and image based response mechanisms such as video or still image transmission.

The promo code usage database 209 contains a complete and current history of which promo codes are assigned to each vendor and offer. This provisioning information is used to prevent duplication of assignment and also permit accurate analysis of the viewer or customer responses.

A media interface module 206 makes communication possible with all the various media channels in order to automatically perform various functions including, among others, gathering the pricing information from the disparate channels. In a preferred embodiment, update of pricing information is an automated process whereby media channels send any changes in pricing as they are made directly to the media interface 206 to the system

A database query processing module 205 is shown in FIG. 2 as gathering data from the media channels for storage in the system. The query processing module 205 also performs all queries that are necessary to create an ad campaign or to assist in the response monitoring and analysis. A promo code interface module 201 provides the ability to capture the customer responses including among others, text messages and keywords sent in response to a particular short code in an advertisement. A promo code processing module 203 takes the captured text messages and keywords and enters them into the appropriate fields in the customer preference database 207 and other databases contained in the system that are necessary to keep track of the volume, timing, and location of each customer response and permit the accurate combined analysis of all the received customer responses.

A campaign management module 214 comprises a number of submodules including a promo code provisioning module 220, an advert template definition module 217, a syndication selection module 218, and advert republish and autoformat module 219.

Daily Deal

In the description herein, an offer is a means to draw a response from a consumer of the offer. Such offers can include, but are not limited to, advertisements, discounts, coupons, membership points, access to events or services, and the like. One type of offer that can be used in the present system is known as a “Daily Deal” (DD). Often a DD will require that the consumer purchase the DD offer, typically at a meaningful discount, in return for goods or services valued at greater than the amount paid for the DD. The behavior of the customer in purchasing the DD allows not only accountability for the effectiveness of offers, but immediate financial benefit to the merchant and publisher as well.

An example of a DD is the offer of a coupon that is worth, for example, $50.00 when used at a particular merchant for goods or services. However, the customer only pays, for example, $25.00 for the coupon. When the customer redeems the coupon by using it at the merchant, it is as if the customer gets $50.00 worth of goods or services for only $25.00.

Each offer has associated with it a plurality of metrics and meta-data that allows network members to determine the value of the offer to themselves. For example, if the offer is a DD, the meta-data would include deal terms for using the offer (e.g. the cost to the consumer to purchase the DD, the amount that goes to the provider of the goods or services associated with the DD, the amount that goes to the publisher of the DD, and the amount that goes to the syndication network member that originally offered the DD to the network). Other meta-data may include the historical conversion rate of the offer, the demographics of purchasers of the offer, the conversion rate of the offer per publishing platform (e.g. for radio, television, print, on-line, and the like). The meta-data could also include temporal related data if the performance of the offer has historically had a temporal based correlation or relationship.

Each offer includes a customizable Call-To-Action (CTA) that allows the consumer to respond to the offer (e.g by purchasing the DD). Because each publisher has its own associated CTA, the system can track the identity of the publisher of the offer to which a consumer is responding. Examples of CTAs that can be used by the system include, but are not limited to, short codes, email, SEM, SEO, a web site (publisher, merchant, third party, etc), social media site (Facebook, Twitter, and the like), telephone number, RFID chip, bar code, QR (Quick Response) codes and the like, wireless mechanisms such as RFID codes and the like, and/or sound based response mechanisms such as audio response and the like, and image based response mechanisms such as video or still image transmission.

Deal Offer To Syndicate

In one embodiment, consider the situation where a merchant proposes a daily deal with a publisher who is a member of the syndicate. The analytics system may be used to generate one or more ad templates for the campaign, including print, television, raido, on-line, and other media. The DD is then made available to the syndicate members. The use of templates allows the system to meet the display needs of any of the publishers in the syndicate, whatever media they may choose. One or more publishers in the syndication network may then choose to participate in that DD and publish it themselves. This may be when the publisher does not have its own daily deal for that day or may believe that the source publisher has a better DD than the network publisher has available. The system also allows local publishers (and merchants) to have national exposure opportunities when the DD is used by other syndicate members.

By sharing a DD in a syndicate, each DD can generate greater revenue than if it were limited to a single publisher. In addition, by providing both on-line and off-line publishing opportunities, the system creates exposure to customers that would otherwise be unreachable. The system provides a variety of economic models associated with each DD. For example, a syndicate member who takes the DD may receive a certain revenue share of the DD for all sales. In other embodiments, the syndicate member is offered a revenue share for only those customers that respond to the offer in that members publication. In other instances, the publisher may receive accelerator payments if a certain number of the DD are converted or sold.

Because the system provides for unique promo codes and calls-to-action for each publisher, the system has the ability to provide accurate accounting of revenue sharing and DD performance. The analytics system also provides the ability to capture and generate meaningful metrics associated with any individual DD as well as entire categories of DDs so that syndicate members can use the marketplace of DDs more effectively. It should be noted that any individual publisher may themselves have one or more on-line and off-line media in which to publish the DD. The publisher can choose the appropriate template for each publishing platform. In other cases, the publisher may choose a different DD for each publishing platform based on associated metrics of the DD.

Deal Offer To Syndicate

In one embodiment, consider the situation where a merchant proposes a daily deal with a publisher who is a member of the syndicate. The analytics system may be used to generate one or more ad templates for the campaign, including print, television, raido, on-line, and other media. The DD is then made available to the syndicate members. The use of templates allows the system to meet the display needs of any of the publishers in the syndicate, whatever media they may choose. One or more publishers in the syndication network may then choose to participate in that DD and publish it themselves. This may e when the publisher does not have its own daily deal for that day or may believe that the source publisher has a better DD than the network publisher has available. The system also allows local publishers (and merchants) to have national exposure opportunities when the DD is used by other syndicate members.

By sharing a DD in a syndicate, each DD can generate greater revenue than if it were limited to a single publisher. In addition, by providing both on-line and off-line publishing opportunities, the system creates exposure to customers that would otherwise be unreachable. The system provides a variety of economic models associated with each DD. For example, a syndicate member who takes the DD may receive a certain revenue share of the DD for all sales. In other embodiments, the syndicate member is offered a revenue share for only those customers that respond to the offer in that members publication. In other instances, the publisher may receive accelerator payments if a certain number of the DD are converted or sold.

Because the system provides for unique promo codes and calls-to-action for each publisher, the system has the ability to provide accurate accounting of revenue sharing and DD performance. The analytics system also provides the ability to capture and generate meaningful metrics associated with any individual DD as well as entire categories of DDs so that syndicate members can use the marketplace of DDs more effectively. It should be noted that any individual publisher may themselves have one or more on-line and off-line media in which to publish the DD. The publisher can choose the appropriate template for each publishing platform. In other cases, the publisher may choose a different DD for each publishing platform based on associated metrics of the DD.

FIG. 3 is a flow diagram illustrating an embodiment of the system in offering a DD to the syndication network. At step 301 a merchant generates a DD. The DD includes the offer and the price to be paid by a customer to obtain the offer. At step 302 the DD merchant includes any meta-data that is to be associated with the DD such as price, value, offer start and end date, redemption deadline, offer limitations and restrictions, and other meta-data that is associated with the DD. In addition, the merchant includes any pricing or other revenue sharing parameters that are to be associated with the DD in the syndicate.

As noted previously, the merchant may offer a variety of incentives to syndicate members to publish the DD in their own platforms. It should be noted, that even if a publisher does not receiver revenue sharing for a particular DD, the publisher may still want to use a DD that has a high conversion rate in order to acquire customers and/or registered users. If the customer must redeem the DD through the publisher engagement system, then the publisher will be able to acquire that customer. Customer acquisition is a valuable asset and allows a publisher to increase their business by acquiring customers.

The revenue sharing can take one or more of many forms, including straight revenue split, tiered revenue sharing based on number of sales, CPC compensation, mumber of page views, and the like. The revenue sharing could also be based on media spend by the receiving publisher. The revenue sharing could also be a barterning deal.

At step 303 the DD is inserted into the system for eventual offering to the syndicate members. It should be noted that the DD may be provided to the system by the merchant who creates the DD or by a publisher who has originally acquired the DD and decides to offer it to the syndicate.

Once the DD is in the system, it is analyzed to determine other metrics that are useful to the syndicate members in making a decision to acquire the DD. At decision block 304 it is determined if there are any existing metrics in the system for this particular deal. This can mean metrics associated with past offers from the same merchant for the same goods or services, or it can be metrics associated with the same publisher for other goods and services, or it can be metrics associated with the same goods and services from other publishers.

If there are deal metrics available at decision block 304, those metrics are associated with the DD at step 305. Each DD exists in the system as a data structure or object which can have a plurality of metrics and characteristics associated with the DD. This allows more intelligent analysis and determination of whether to acquire the DD on the part of syndicate members.

After step 305, or if there are no deal metrics at block 304, the system proceeds to decision block 306 to determine if there are category metrics associated with the DD. For example, the DD may be for a particular type of good, such as a product, meal, or the like, or a particular type of service, such as spa treatment, haircut, auto service, and the like. If the system has metrics available for the particular category of DD, then those metrics are associated at step 307.

After step 307, or if there are no category metrics at block 306, the system proceeds to step 308 and the DD is offered to the network.

Acceptance Process

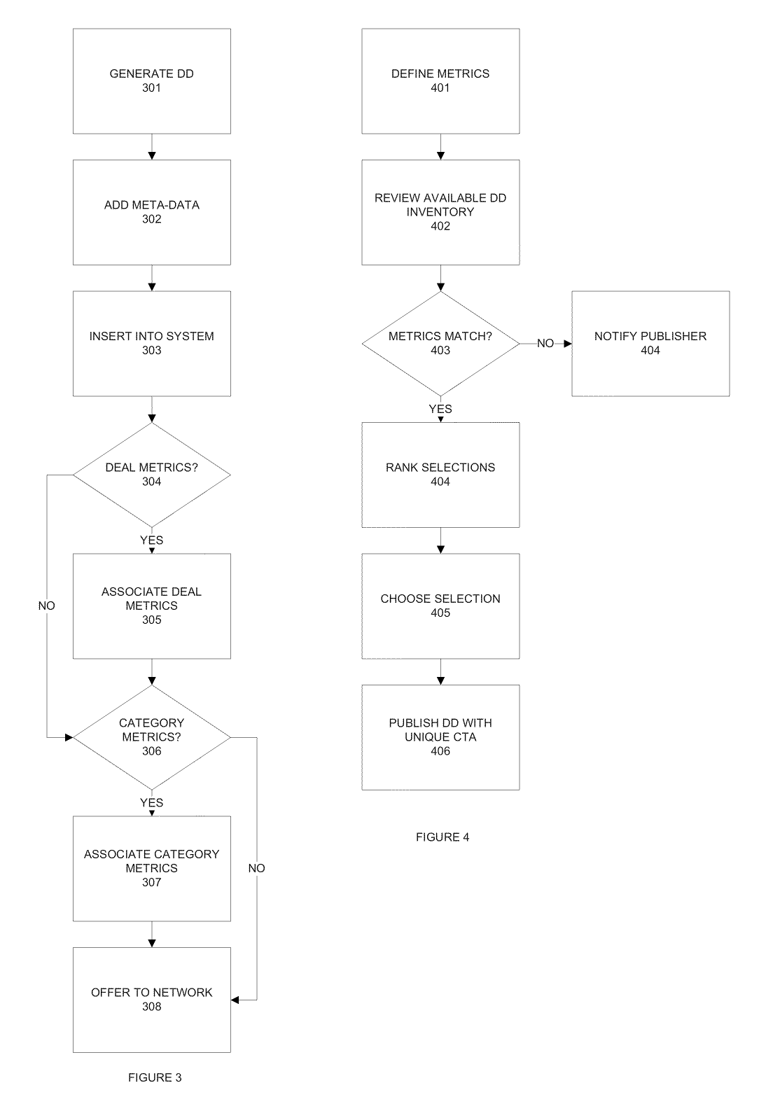

FIG. 4 is a flow diagram illustrating the operation of a receiving publisher in acquiring a DD with attached media spend in an embodiment of the system. At step 401 the receiving publisher receives the DD with media spend from the offering publisher (or via the syndicate system). At step 402 the receiving publisher determines the format for publishing on its platform. If there is a required format, the receiving publisher must provide at least that format to use the DD. However, the receiving publisher can publish the DD in a larger format if desired to maximize the return on the DD. The media spend, for example, might cover the cost of a quarter page ad in a newspaper. However, the receiving publisher is permitted to publish the DD in a full page ad if desired, using the media spend to offset at least some of that opportunity cost.

At step 403 the receiving publisher publishes the DD on its platform. At step 404 the receiving publisher provides an accounting to the offering publisher of the publishing of the DD and the number of views or other metric to determine how much of the media spend is actually owed to the receiving publisher. At step 405 the parties finalize the financial aspects of the transaction pursuant to the offer and performance.

Campaign Management

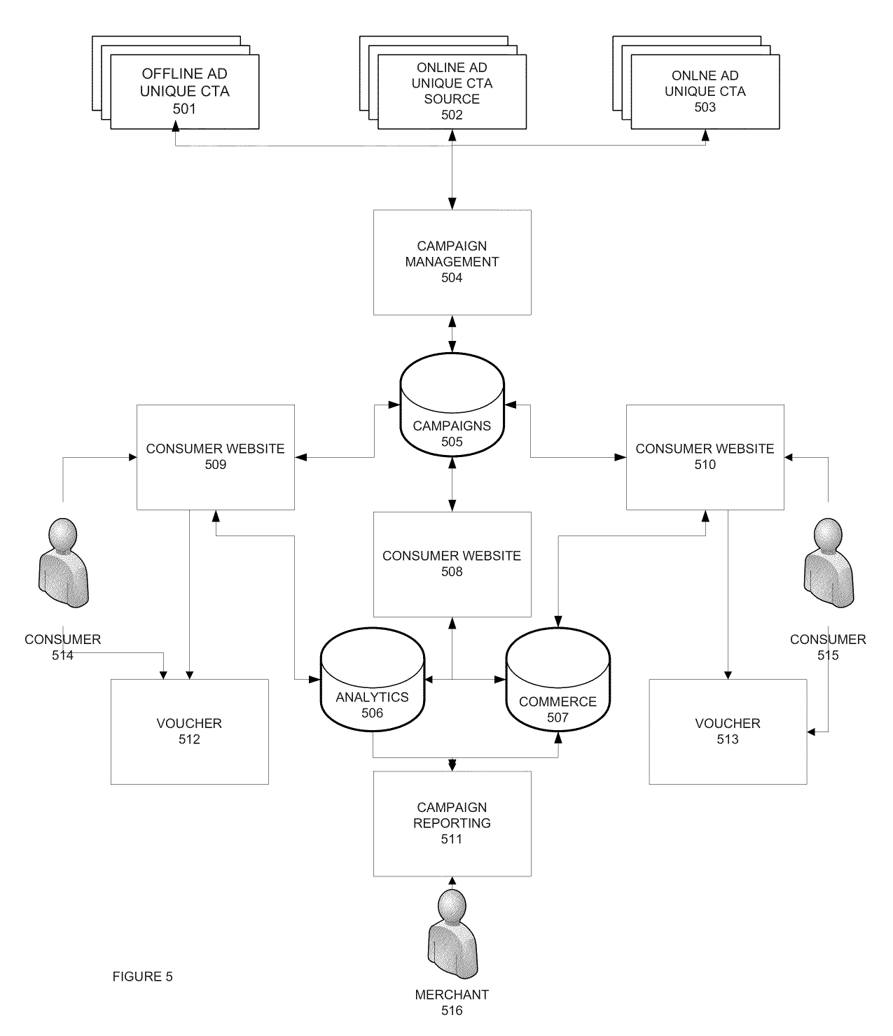

FIG. 5 illustrates the operation of a DD transaction in one embodiment of the system. In this example a merchant 516 has created a DD and provided it to source publisher 502. The source publisher has made the DD available to the network with attached media spend and publishers 501 and 503 have elected to publish the DD. In this example publisher 501 is an offline publisher while publishers 502 and 503 are online publishers. However, it is possible that each publisher has one or more online and/or offline publishing platforms for offering the DD.

Each of the publishers presents the DD as an offer with a unique CTA that allows the system to identify the publisher and the platform to which a customer (e.g. consumer 514 or consumer 515) is responding. The publishers are coupled to the system through the campaign management module 504 to the campaigns database 505. Although only a few publishers are shown in FIG. 5, the system is fully scalable and may manage any number of offers as well as any number of publishers who elect to participate in the system.

When consumer 514 elects to purchase the DD, the unique CTA directs the consumer to a consumer website 509 that is used for accepting payment and for providing some indicia (e.g. voucher 512) that is used by the consumer 514 for fulfillment of the offer with merchant 516. In some cases, the website may be the website of the publisher, or an associated website. The advantage of directing the consumer 514 to a unique instance of a website is that the publisher can acquire the customer via a required registration process during the voucher transacation. For example, if publisher 501 is a newspaper, the consumer may be required to register with the newspaper as part of the voucher acquisition process. Similarly, consumer 515 is directed to consumer website 510 (perhaps associated with or owned by publisher 503) to purchase voucher 513.

Even if the consumer is already a registered customer of the publisher, the publisher gains valuable demographic data about the customer's preferences and purchasing habits. In one embodiment, there is not only a unique CTA for each publisher and each platform, but for each type of device on which the DD appears. For example,

Publisher 503 will have a unique CTA for the DD when it appears on the publishers mobile platform, tablet platform, or desktop platform. This provides additional unique information about the consumer and about the efficacy of the DD and other promotions.

Information about the voucher transactions, from any website, are forwarded to the analytics engine 506 and commerce module 507. Analytics 506 is used to evaluate the effectiveness of the offer and to determine if changes should be made to the campaign, either during the campaign itself, or in future campaigns. The commerce module 507 is used to aid in handling the financial aspects of the voucher transactions, as well as providing accounting and payments to the source publisher and receiving publisher for syndicated offers., as well as to the merchant 516 The campaign reporting module 511 provides offer statistics to the merchant who will provide the goods and/or services associated with the DD and the attached media spend.

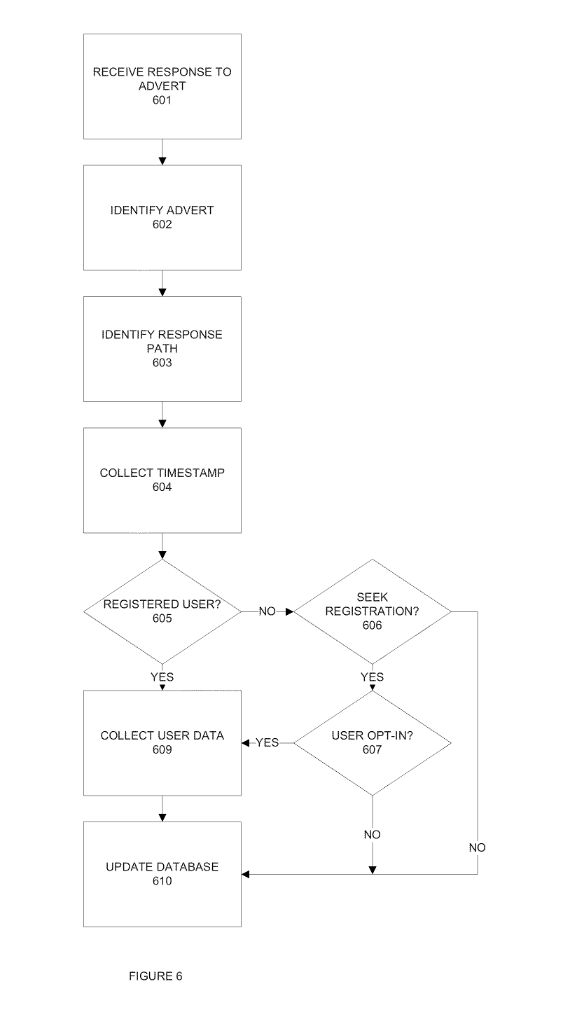

FIG. 6 is a flow diagram illustrating the operation of the campaign management when a consumer responds to an offer. It should be noted that the response does not need to be a purchase. There are many levels of response that are of interested to the publishers and other syndicate members, including visiting the website via the CTA, registration without purchase, non-purchase activity on the website (reviewing other deals, clicking on ads, and the like) and registration without purchase.

At step 601 the system receives a response from a user. At step 602 the system analyzes the response to determine the offer to which the consumer is responding. As noted above, this can be via decoding the CTA that is used by the consumer to consummate the response. At step 603 the system identifies the response path. This can be via cell phone, voice mail, messaging, email, web site, social media, and the like. At step 604 the system collects the time stamp information of the response. This allows the system to analyze how quickly the consumer has responded to the offer, which is one gauge of the effectiveness of the advert.

At decision block 605 the system determines if the user is a registered user. (Note in some embodiments, the consumer must register or sign in contemporaneously with responding to the ad). If not, the system proceeds to decision block 606 to determine if the system should seek the registration of the consumer. In some campaigns, the merchant or publisher may prefer to require (or at least ask for) registration of the user. This can provide additional demographic information about the consumer that is very useful in measuring ad effectiveness. In other campaigns, the merchant or publisher might not require any registration in the hopes of increasing the number of responses.

If registration is sought at step 606, the system proceeds to step 607 to determine if the consumer has opted in to the registration process. If so, and if the user was registered at step 605, the system proceeds to step 609 and collects the user data associated with the responder. After step 609, and if there is no desire to seek registration and/or no opt-in by the consumer responder, the system updates the database with all available information.

Offer Metrics

One of the advantages of the system is the useful data that can be accumulated over time with respect to the plurality of offers. Some of the metrics that might be associated with the DD include, but are not limited to, the following:

(1) Cost per Click (CPC) for media spend on the DD. (2) Cost per Click for mobile text messages. The cost per click for mobile text messages is the cost per text message sent by the advertiser plus the cost for receiving the text message divided by the number of unique viewer clicks. Cost for receipt of message is included in this calculation because carriers charge for messages both sent and received. (3) Clicks or viewers per key word. Each keyword placed in an advertisement will receive a certain number of clicks from viewers.

(4) Clicks or viewers per key word by geographic region, (5) Clicks or viewers per key word by market segment such as health care, beauty, travel, and entertainment among others, (6) Clicks or viewers by key word by market and submarket segment such as beauty, luxury or hotels, economy, (7) Clicks or viewers by keyword and demographic profile such as area code, associated zip code, inferred median income, (8) CPC score based upon target market segment, (9) Percentage of target audience reached based upon last previous click, (10) Percentage of target audience reached based upon previous 100 clicks, (11) Percentage of target audience reached based upon entire click history, (12) CPC for one media campaign versus any other media campaign contained within the system. (13) A/B reporting CPC and number of viewers between two similar campaigns using identical keywords to determine ad effectiveness and overall value of one advertisement versus another advertisement, (14) Coefficient correlation or efficiency between many different campaigns but in the same market segment. (15) Coefficient correlation or efficiency of two similar campaigns determined by identical market segment where viewers clicked on both campaigns. (16) Demographics of expected responders (based on historical data). (17) Expected gross return for DD per publishing platform and per access platform. (18) Expected registration rate. (19) E-mail registration traffic. (20) Searches based on link access.

Syndicate Member Interface

One advantage of the system is the ability to define requirements for offers on any publishing platform on day or time of day, as well as the type of responding device. The system provides an interface for syndicate members to define offers metrics, publishing platforms, response platforms, goods categories, revenue share, and all the other metrics associated with an offer. The system can then search the syndicate for offers that match the requirements of the publisher as defined by the interface and select those offers for publication. If no matching offer is available, the system can rank the available offers and suggest one or more to the publisher or simply notify the publisher that there are no matching offers. If there are a plurality of matching offers, the system can rank them pursuant to weights and rankings defined by the publisher.

The interface is used by the syncidate members to implement step 401 of FIG. 4. FIG. 7 is a flow diagram illustrating one embodiment of defining offer metrics in the system. This may be done through campaign management 102 of FIG. 1, or via campaign management 504 of FIG. 5.

At step 701 the publisher opens the interface. At step 702 the publisher defines the time period for which the offer is desired. This can be a specific and one time date, it can be a recurring date (e.g. every Thursday), a date range, or any other temporal metric that is of interest to the publisher. At this stage the publisher may also want to define a suitable length of time for the offer. For example, for some DD's, the benefit of the offer has a fixed time period. In most states, the consumer can never get less than what was paid for an offer, but the merchant is able to set a cutoff date by which the offer must be used to obtain the full advantage of the discount.

At step 703 the publisher selects the publishing platform for which the offer is desired. Using the interface the publisher can select one or more print media (newspaper, magazine, inserts, coupons, advertising supplement, and the like), visual media (television, on-line media players, etc.), audio media (radio, on-line audio ads, etc.), on-line platforms (the publisher's own website, other online locations, and the like), or other publishing platforms. At this point, more than one platform may be defined if desired.

At step 704 the publisher defines one or more response platforms. This may include mobile devices, tablets, desktops, telephones, smartphones, desktop systems, QR code readers, and the like. Each offer will include meta-data indicating the types of response platforms that can be used to respond to the offer.

At step 705 the publisher selects the category of offer of interest. For example the publisher may select restaurants, spas, markets, in-home services, health and beauty, personal services, and the like. At step 706 the publisher may select one or more specific goods and/or services of interest. For example, if the publisher has selected the restaurant category, the publisher may here indicate one or more types of restaurant (e.g. steakhouse, Italian, Sushi, and the like). At step 707 the publisher may select the geographic region where the goods and/or services are provided.

At step 708 the publisher selects deal specific parameters associated with the offer, such as revenue share, payment terms, customer registration share, and the like. At step 709 the publisher can select from all other metadata and metrics associated with the offer, such as those described above relating to offer metrics (e.g. cost per click, conversion rate, etc.). It should be noted that for many of these parameters, the publisher can select a range of values within which an offer will qualify as a matching offer (e.g. 7-15% conversion rate, $2-$5 CPC, and the like). In one embodiment, these metrics can be defined per publishing platform and per response platform as desired.

At step 710, the publisher, if desired, may define parameters that should not be present in the offer. At step 711 the system asks the publisher to weight or rank the selected parameters. For example, the system may have a sliding or numeric scale associated with each selection (e.g. from 1-10) and the publisher will indicate importance of each parameter upon selection. In other instances the publisher can order the selected parameters from most important to least important. This weighting and ranking allows the system to determine which offer is the best match when more than one offer is qualified.

At step 712 the publisher finalizes the selections. The publisher is free to define as many offer selections as desired using the system.

Analytics

The system responds to feedback from performance of the campaigns to provide fine tuning and in-campaign modification and adjustments to improve campaign performance. The system also generates data and metrics to improve future campaign planning and efficiency. The system uses analytic algorithms and processes in the Campaign Management Module 214, Response Analysis Module 215, and Campaign Management 504 to manage each campaign and to adjust in real-time to maximize campaign effectiveness.

In one embodiment of the specification, the system analyzes individual instances of an ad/offer for effectiveness. (In this discussion, ad and offer are used interchangeably). For example, in the context of an off-line newspaper ad, the system will analyze the effectiveness of the ad each time it is published in the newspaper. An ad that runs on Tuesday will be analyzed separately from an ad that runs on Friday. This allows the system to fine tune an ad for effectiveness at its time of publication. Similarly, an on-line ad will be analyzed for its effectiveness at its publication time, including factors such as web site of publication and other metadata associated with the ad.

The system also analyzes ads for their effectiveness in the platform of delivery. For example, an off-line newspaper ad will be analyzed for its effectiveness over all instances of publication. Similarly, an on-line ad will be analyzed for its effectiveness during the campaign overall, in addition to each instance.

The system may also analyze an ad for its effectiveness in a historical context, compared to collected data. This data may be product and offering vendor specific, may be product category specific, publishing platform specific, or any combination.

When ads are found to be performing below expectations, they are modified in one or more ways to increase their effectiveness. This may entail modifying the ad itself but maintaining the same delivery or publishing platforms and timing of publication. It may involve keeping the ad as-is and changing the publication platforms and/or delivery times to increase the effectiveness of the ad. In one embodiment, it may entail both modifying the ad and changing one or more factors of publishing platform and delivery time.

Ad/Offer Instance Analysis

FIG. 9 is a flow diagram of an embodiment of the system in analyzing the instance of publication of an ad. At step 901 the system identifies an ad and an instance of publication for analysis. At step 902 the system collects all relevant data associated with that ad, including the data generated from the response system of FIG. 6. The data also includes identification of the template definition module 217 for that ad, a list of the keywords of the ad, the pricing of the offer, the benefit offered, and other related data.

At step 903 the system updates the database for the metrics associated with the ad, including in one embodiment a histogram of the data for analysis purposes. AT step 904 the system compares the collected metrics to target metrics for that ad on that platform at that time of publication. These target metrics may be defined by the publisher or advertiser, or may be based on historical data, or may be based on trends (e.g. the metrics should be improving over time). The data may include click-throughs, conversions, and other known performance data.

At decision block 905 the system determines if the metrics are above the target threshold. If so, the system maintains the ad at step 906. If not, the system modifies the ad at step 907.

Platform Analysis

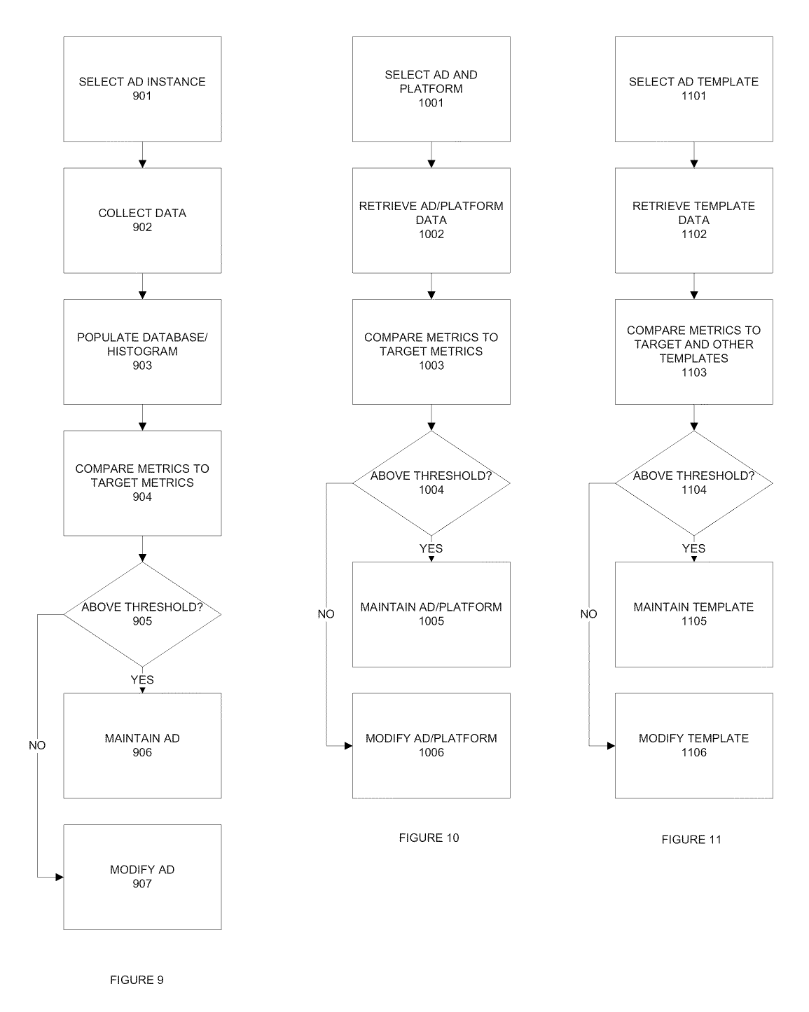

FIG. 10 is a flow diagram illustrating the operation of the system in analyzing the effectiveness of an ad/offer on a publishing platform over the life of a campaign, including all instances of publication on the platform. At step 1001, the system selects an ad and a publishing platform for analysis. The publishing platform may be online or offline.

At step 1002 the system collects the data for the publishing platform, including all the data collected from the operation of FIG. 6 and any data collected at step 903 of FIG. 9 (or in a similar operation). At step 1003 the system compares the ad/platform database metrics to target metrics for the ad/platform.

At decision block 1004 it is determined if the metrics are above the threshold level. If so, the system proceeds to step 1005 and maintains the ad as is. If not, the system proceeds to step 1006 and modifies the ad on that platform.

Ad/Offer Template Analysis

FIG. 11 is a flow diagram illustrating the analysis of a campaing at an ad template level. In one embodiment, the system generates ad templates for use in a campaign. Any particular ad template may be used on multiple publishing platforms. It would be useful to determine if the ad template is performing well on each platform, as well as to determine its effectiveness as compared to other ad templates.

At step 1101 the system selects an ad template to analyze. At step 1102 the system retrieves at template data, such as generated by the operation of FIG. 6. At step 1103 the system compares the ad template data to target/template metrics. The system may have, in one embodiment, target metrics for the ad template. In other instances, the system may compare the effectiveness of the ad template to other ad templates that are part of the campaign and determine where the ad template ranks compared to the other templates.

At decision block 1104 the system determines if the ad template is meeting the targets. If so, the system maintains the ad template at step 1105. If not, the system modifies the ad template at step 1106.

Ad/Offer Modification

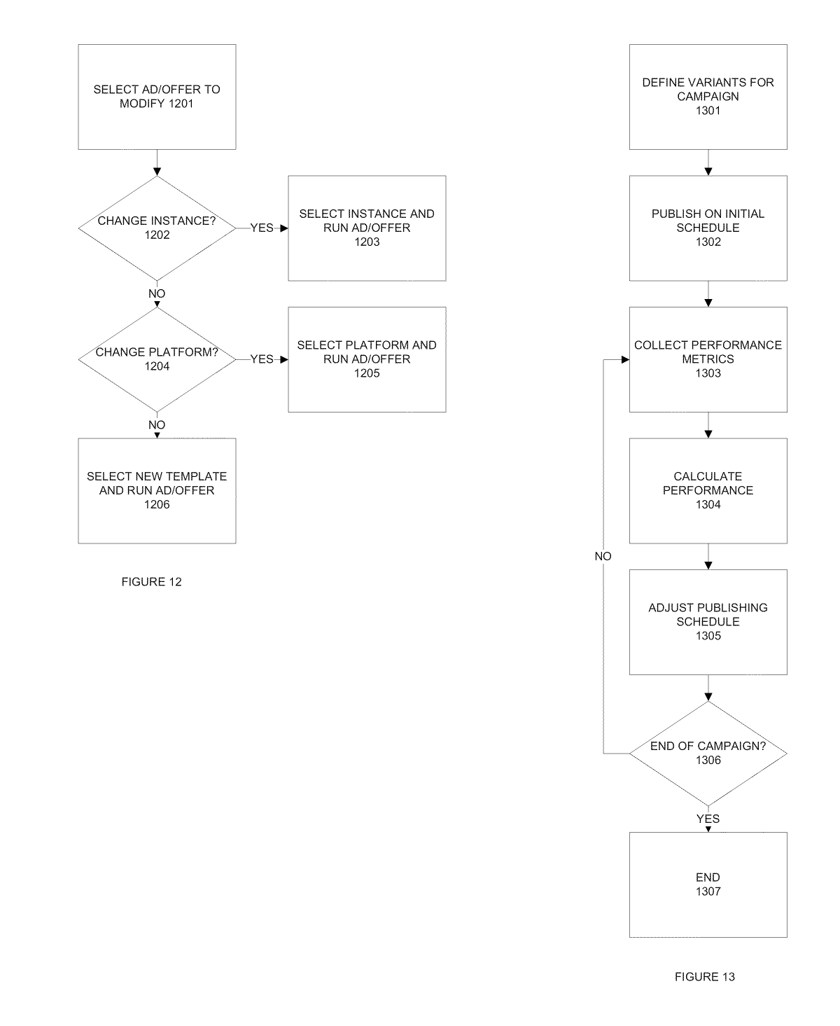

If the performance metrics of an ad are below target metrics, the system allows for the modification of the ad in a dynamic manner to improve the performance of the campaign. FIG. 12 is a flow diagram of the modification of an ad/offer in one embodiment of the system. At step 1201 the system selects the ad/offer to modify. At step 1202 the system determines if the instance will be changed. (In some cases, media spends are pre-paid and it may be difficult to change the instance of publication without adding unwanted costs to the campaign). If the instance is to be changed, the system proceeds to step 1203 and reviews other available instances to run the ad/offer and selects the best available instance based on predicted and/or historical data for the offer, product, or category.

If the instance is not to be changed, the system next determines if the publishing platform is to be changed at step 1204. If so, the system reviews available publishing platforms and selects the best available platform based on predicted and/or historical performance data for the available publishing platforms.

If the platform is not to be changed, the system proceeds to step 1206. At this point, the ad template is to be changed. At this point, the system reviews predicted and/or historical performance data for available ad/offer templates and selects the best template available and runs the ad/offer with the new template.

It should be noted that the available performance data can include a number of metrics. In some cases, each word in each ad template is tracked historically for performance at instance, platform, and template, so that changing an ad template may involve changing a word in the ad/offer to a higher performing term. In other instances, the template may have a different cost or premium, to make the offer more tempting to a consumer. This data is also tracked historically so that the most cost effective ad/offer may be made at the right time.

Stepwise Modification

FIG. 13 is a flow diagram illustrating a process for selecting variants of a campaign in an embodiment of the system. At step 1301 the system defines a plurality of campaign variants in a database. Each variant is an offer that is part of the campaign but may differ in one or more factors including offer cost, value, timing, platform, content, wording, and the like. The number of variants is determined by the offer. At step 1302 an initial schedule is determined for presentation of each variant. In one embodiment the schedule may be the presentation of all variants with equal frequency over some time period so that all variants are published.

At step 1303 the performance metrics for each variant are collected. At step 1304 the system calculates the performance of each variant. As noted previously, the performance metrics can include conversions, purchase, opt-ins, inquiries, and the like. Different weights can be given to each metric by the system to arrive at an overall performance score and compared to a target performance value.

At step 1305, the relative publishing frequency of each variant is adjusted by a small amount in proportion to its actual performance relative to the target performance. In other words, a variant that is under-performing has its frequency reduced and a variant that is over-performing (or perhaps under-performing less) has its frequency increased. After step 1305 the system determines if the campaign has ended at decision block 1306. If so, the system ends at step 1307. If not, the system returns to step 1303. After several iterations, the average performance of the campaign is optimized because the better-performing variants end up being used with a higher frequency.

To buffer the impact of the adjustments, there may be a “rate constant” that governs how much the frequencies are adjusted at each round, and there may be a “regularization term” in the algorithm that prevents the lower-performing templates from disappearing completely, so that the algorithm can continue to monitor their performance and raise their frequencies if the conditions change over time (i.e. if the metric of the formerly underperforming variants improve).

### Embodiment of Computer Execution Environment (Hardware)

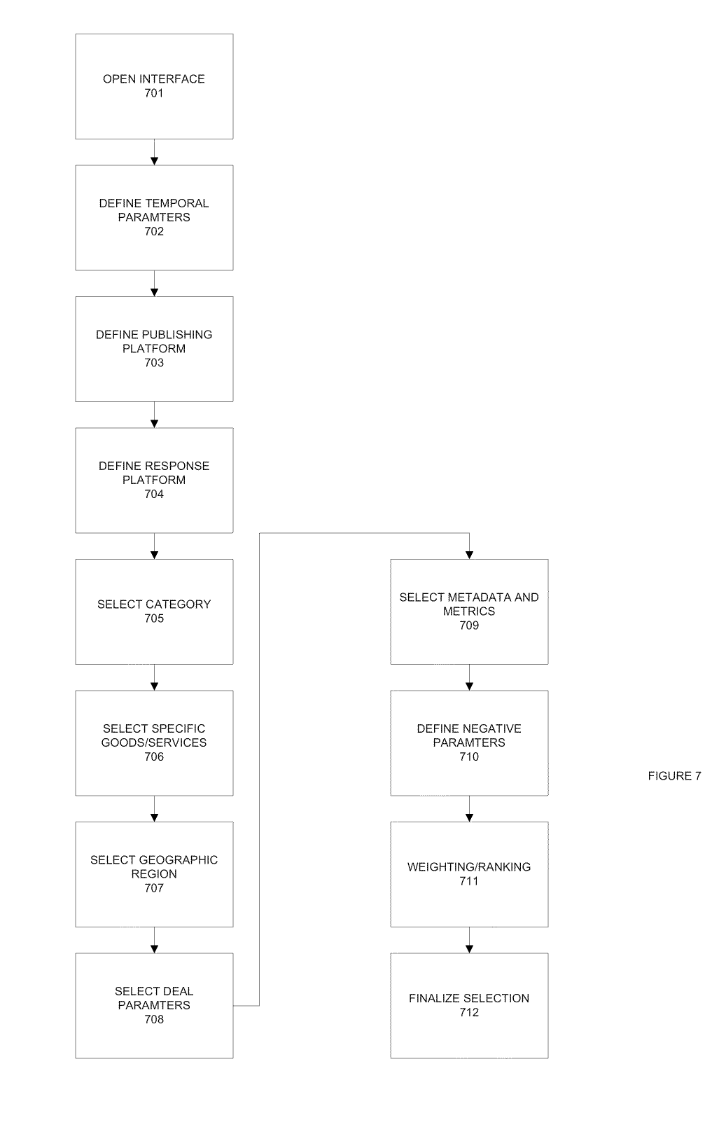

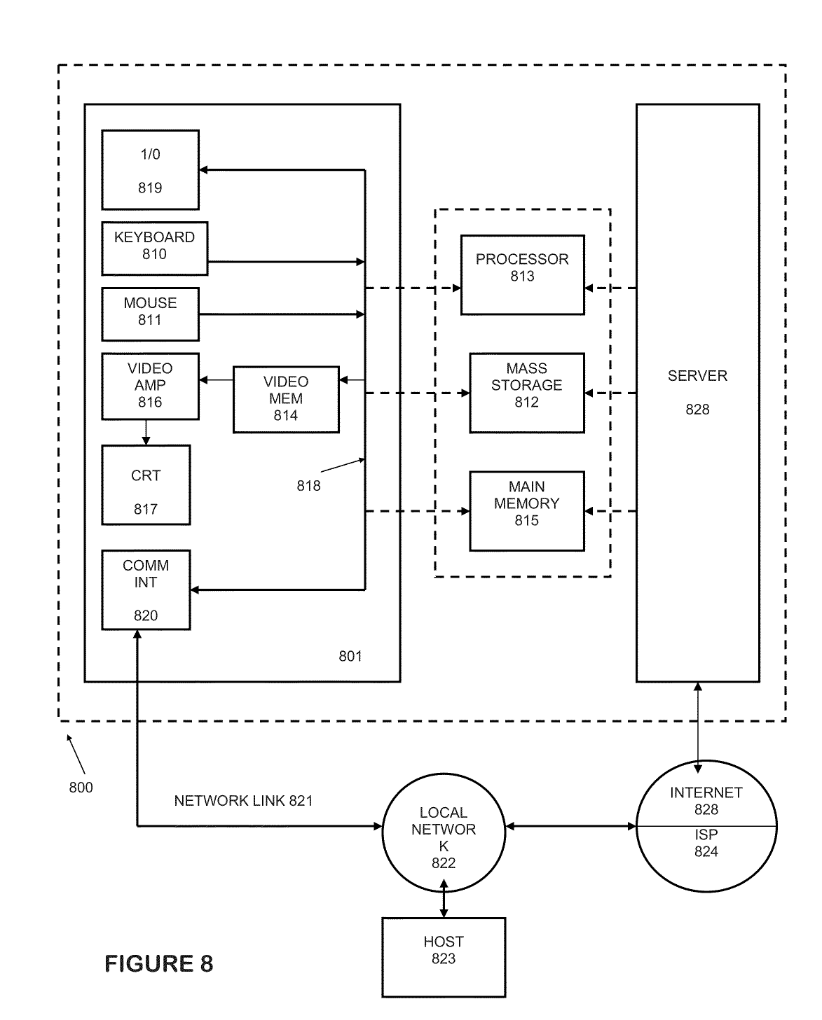

An embodiment of the system can be implemented as computer software in the form of computer readable program code executed in a general purpose computing environment such as environment 800 illustrated in FIG. 8, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 810 and mouse 811 are coupled to a system bus 818. The keyboard and mouse are for introducing user input to the computer system and communicating that user input to central processing unit (CPU 813. Other suitable input devices may be used in addition to, or in place of, the mouse 811 and keyboard 810. I/O (input/output) unit 819 coupled to bi-directional system bus 818 represents such I/O elements as a printer, A/V (audio/video) I/O, etc.

Computer 801 may include a communication interface 820 coupled to bus 818. Communication interface 820 provides a two-way data communication coupling via a network link 821 to a local network 822. For example, if communication interface 820 is an integrated services digital network (ISDN) card or a modem, communication interface 820 provides a data communication connection to the corresponding type of telephone line, which comprises part of network link 821. If communication interface 820 is a local area network (LAN) card, communication interface 820 provides a data communication connection via network link 821 to a compatible LAN. Wireless links are also possible. In any such implementation, communication interface 820 sends and receives electrical, electromagnetic or optical signals which carry digital data streams representing various types of information.

Network link 821 typically provides data communication through one or more networks to other data devices. For example, network link 821 may provide a connection through local network 822 to local server computer 823 or to data equipment operated by ISP 824. ISP 824 in turn provides data communication services through the world wide packet data communication network now commonly referred to as the “Internet” 825 Local network 822 and Internet 825 both use electrical, electromagnetic or optical signals which carry digital data streams. The signals through the various networks and the signals on network link 821 and through communication interface 820, which carry the digital data to and from computer 800, are exemplary forms of carrier waves transporting the information.

Processor 813 may reside wholly on client computer 801 or wholly on server 826 or processor 813 may have its computational power distributed between computer 801 and server 826. The processing functionality can be provided via cloud servers or cloud processing systems. Server 826 symbolically is represented in FIG. 8 as one unit, but server 826 can also be distributed between multiple “tiers”. In one embodiment, server 826 comprises a middle and back tier where application logic executes in the middle tier and persistent data is obtained in the back tier. In the case where processor 813 resides wholly on server 826, the results of the computations performed by processor 813 are transmitted to computer 801 via Internet 825, Internet Service Provider (ISP) 824, local network 822 and communication interface 820. In this way, computer 801 is able to display the results of the computation to a user in the form of output.

Computer 801 includes a video memory 814, main memory 815 and mass storage 812, all coupled to bi-directional system bus 818 along with keyboard 810, mouse 811 and processor 813.

As with processor 813, in various computing environments, main memory 815 and mass storage 812, can reside wholly on server 826 or computer 801, or they may be distributed between the two. Examples of systems where processor 813, main memory 815, and mass storage 812 are distributed between computer 801 and server 826 include thin-client computing architectures and other personal digital assistants, Internet ready cellular phones and other Internet computing devices, and in platform independent computing environments, In other embodiments, memory and/or storage may reside, in whole or in part, in a cloud system.

The mass storage 812 may include both fixed and removable media, such as magnetic, optical or magnetic optical storage systems or any other available mass storage technology. The mass storage may be implemented as a RAID array or any other suitable storage means. Bus 818 may contain, for example, thirty-two address lines for addressing video memory 814 or main memory 815. The system bus 818 also includes, for example, a 32-bit data bus for transferring data between and among the components, such as processor 813, main memory 815, video memory 814 and mass storage 812. Alternatively, multiplex data/address lines may be used instead of separate data and address lines.

In one embodiment of the invention, the processor 813 is a microprocessor such as manufactured by Intel, AMD, Sun, etc. However, any other suitable microprocessor or microcomputer may be utilized. Main memory 815 is comprised of dynamic random access memory (DRAM). Video memory 814 is a dual-ported video random access memory. One port of the video memory 814 is coupled to video amplifier 816. The video amplifier 816 is used to drive the cathode ray tube (CRT) raster monitor 817. Video amplifier 816 is well known in the art and may be implemented by any suitable apparatus. This circuitry converts pixel data stored in video memory 814 to a raster signal suitable for use by monitor 817. Monitor 817 is a type of monitor suitable for displaying graphic images.

Computer 801 can send messages and receive data, including program code, through the network(s), network link 821, and communication interface 820. In the Internet example, remote server computer 826 might transmit a requested code for an application program through Internet 825, ISP 824, local network 822 and communication interface 820. The received code maybe executed by processor 813 as it is received, and/or stored in mass storage 812, or other non-volatile storage for later execution. In this manner, computer 800 may obtain application code in the form of a carrier wave. Alternatively, remote server computer 826 may execute applications using processor 813, and utilize mass storage 812, and/or video memory 815. The results of the execution at server 826 are then transmitted through Internet 825, ISP 824, local network 822 and communication interface 820. In this example, computer 801 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

What is claimed is:

1. A method of determining accountability of an advertising campaign comprising:
defining a set of key variables associated with an advertising campaign;
collecting data associated with the key variables for each transaction during the advertising campaing;
analyzing the performance of the advertising campaign based on the key variables;
generating adjustments to the key variables based on the analysis of the performance.

2. The method of claim 1 wherein the key variables are defined for each publishing platform of the advertising campaign.

3. The method of claim 1 further including generating a histogram of the key variables based on all transactions of the advertising campaign.

4. The method of claim 1 further including modifying the advertising campaing based on the adjusted key variables.

5. The method of claim 1 wherein analyzing the performance of the advertising campaign includes weighting the key variables of the advertising campaign.

6. The method of claim 2 further including determining effectiveness of the advertising campaign on each platform.

7. The method of claim 6 further including increasing advertising on the higher performing platforms.

8. The method of claim 7 further including reducing advertising on lower performing platforms.

9. The method of claim 1 further including measuring the key variables for response platforms.

10. The method of claim 1 wherein the advertising campaign includes unique calls to action on each publishing and response platform.
